(19) United States
(12) Patent Application Publication
(10) Pub. No.: US 2013/0232482 A1
(43) Pub. Date: Sep. 5, 2013

(54) METHOD AND SYSTEM FOR DEPLOYING SaaS (SOFTWARE AS A SERVICE) SERVICE BUNDLES

(71) Applicants: Sathyamurthy Dattahreya Hassan, Mysore (IN); Ravi Kumar Gullapalli, Bangalore (IN); James C. Pruyne, Naperville, IL (US)

(72) Inventors: Sathyamurthy Dattahreya Hassan, Mysore (IN); Ravi Kumar Gullapalli, Bangalore (IN); James C. Pruyne, Naperville, IL (US)

(73) Assignee: HEWLETT-PACKARD DEVELOPMENT COMPANY, LP., Houston, TX (US)

(21) Appl. No.: 13/811,616

(22) PCT Filed: Jun. 7, 2011
(86) PCT No.: PCT/IN11/00381

§ 371 Date: Jan. 22, 2013

(30) Foreign Application Priority Data
Jul. 27, 2010 (IN) 2128/CHE/2010

(51) Int. Cl. G06F 9/445

(52) U.S. Cl. CPC G06F 8/61
USPC 717/178

(57) ABSTRACT

Presented is a method, system and computer readable executable code for deploying a SaaS (Software as a Service) service bundle. A computer application is compiled to generate at least one service bundle and a first message containing a first location of the at least one service bundle is posted. Then, a secure copy of the at least one service bundle at a second location is generated and a second message containing the second location of the at least one service bundle is posted. A service bundle is deployed based upon the second location contained in to the second message.

### BACKGROUND

The increased penetration of computing and mobile devices has resulted in a huge demand for software or computer applications. The improvement in data transmission technologies has also helped the cause in a big way. With ever growing demand for useful computer applications and products, software vendors are coming out with novel ways to deliver products to end users. SaaS or “Software as a Service” is one such model. SaaS provides a mechanism of delivering a software product to a consumer and challenges the more traditional model of delivering a computer application as a packaged product. SaaS may be defined as a model of software delivery whereby a computer application is hosted by a service provider and delivered to end users over a network, such as the internet.

SaaS provides a new paradigm of delivering software to customers. It leverages on Service Oriented Architecture (SOA) to provide on-demand delivery of computer applications. It is rapidly gaining acceptance among customers, from single users to large corporations, considering the ease and speed of adoption and reduced costs. It has been analyzed that consumption of software based on SaaS model significantly saves cost to a user when compared to the traditional mode of installing a computer application on a single or multiple set of computer systems.

However, adoption of SaaS presents several challenges for the participants involved, especially for independent software vendors (ISVs) and SaaS platform providers.

### BRIEF DESCRIPTION OF THE DRAWINGS

For a better understanding of the solution, embodiments will now be described, purely by way of example, with reference to the accompanying drawings, in which:

FIG. 1 shows a block diagram of a system for deploying SaaS service bundles according to an embodiment.

FIG. 2 shows a flow chart of a computer-implemented method of deploying SaaS service bundles according to an embodiment.

FIG. 3 shows a block diagram of a client or server computer system that may be used in the system of FIG. 1 according to an embodiment.

### DETAILED DESCRIPTION OF THE INVENTION

SaaS offers a unique value proposition for software vendors and consumers. For software vendors, the benefits may accrue in the form of a shorter product lifecycle development and ability to make frequent upgrades to the product, which makes it easier for them to offer new applications or services to the market. From an end user's perspective, SaaS may considerably reduce the cost of using a computer product—the customer is saved from the cost of owning the product and pays only for the usage. SaaS provides a win-win situation for both the vendor and the consumer.

However, as mentioned earlier, adoption of SaaS may present several challenges for the players involved, especially for independent software vendors (ISV) and SaaS platform providers. For example, it is often challenging for the platform providers to build, distribute and update a platform. For service providers also, it's challenge to build, distribute and maintain the services, since the services may undergo a regular cycle of development, building, deployment and update over time.

Proposed is a solution to manage the distribution of services by service providers. The solution automates the process of distribution and ensures the integrity of the service environment. Accordingly, embodiments of the present solution provide a method, system and computer executable code for deploying SaaS service bundles using a messaging infrastructure.

For clarity and convenience, the following definitions are used herein:

The term “SaaS platform” refers to a combination of software and/or hardware architecture that serves as a base for running a software or computer application. It may typically include a computer's architecture, operating system, programming and user interfaces, etc.

The term “SaaS service” refers to providing a computer application or product based on a SaaS model or platform.

The term “service bundle” refers to computer applications that are provided (to a user) in the form of bundles (or components). For example, in an OSGi (Open Services Gateway initiative) environment, a bundle consists of a set of JAVA packages providing a specific function. A bundle may provide a service or a set of services.

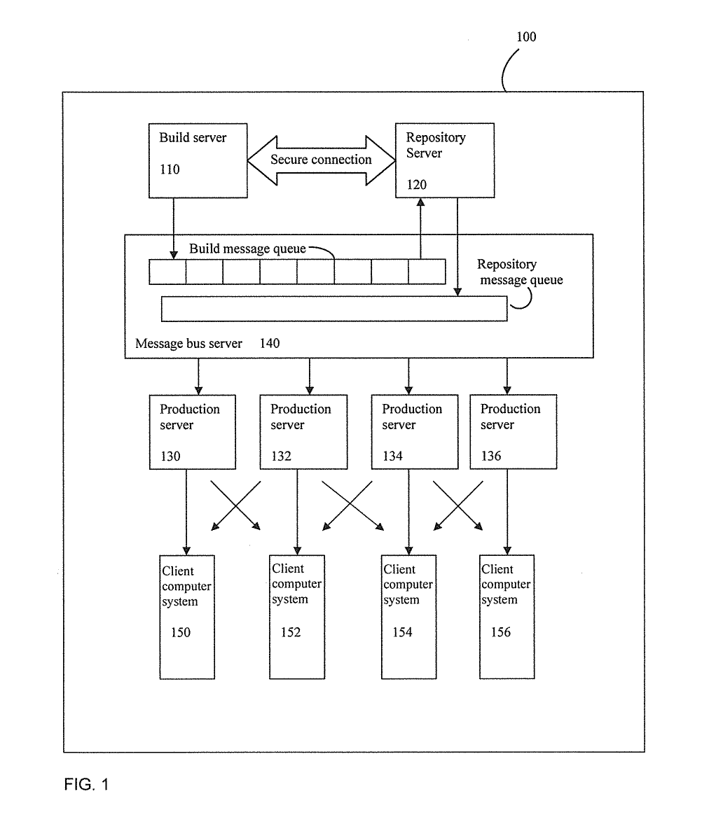

FIG. 1 shows a block diagram of a system 100 for deploying SaaS service bundles according to an embodiment.

In an embodiment, SaaS services (service bundles) may be distributed in an OSGi (Open Services Gateway initiative) environment. Open Services Gateway initiative is an open standards organization that aims to provide a standard framework for providing interoperability between a service provider and a software developer. It uses the JAVA programming language's platform independence feature to provide development of platform independent applications. In an end-to-end client-server architecture, the server provides applications to clients in the form of “bundles,” which are self-installable applications packages in a standard JAVA archive (JAR) file. A JAR file aggregates many files into one and is typically used to distribute Java applications or libraries, in the form of classes and associated metadata and resources (text, images, etc.), thus, enabling a bundle to provide a package of services.

Referring to FIG. 1, the system includes a plurality of server computers 110, 120, 130, 132, 134, 136, 140 and a plurality of client computer systems 150, 152, 154, 156 in a client-server architecture. A server computer may be any combination of hardware or software designed to provide services to clients. Also, each server computer may be a web server (providing a web application to a plurality of client computer systems) or a special purpose server hosting a custom-made application. Each client computer system may be a desktop computer system, a laptop computer, a mobile device, etc. Further, the plurality of server computers 110, 120, 130, 132, 134, 136, 140 and client computer systems 150, 152, 154, 156 are connected together via a network, such as intranet and the internet, which may be wired or wireless.

In an embodiment, the plurality of server computers 110, 120, 130, 132, 134, 136, 140 may include the following servers: a build server 110, a repository server 120, a plurality of production servers 130, 132, 134, 136 and a message bus server 140.

Build server 110 is a computer server where the source code of one or more SaaS services (computer applications) is compiled and bundled as a service bundle JAR. Typically, a build process involves taking the source code and other configuration data as input and producing a desired object as an output. The output (zip file, image, text, etc.) depends on the input parameters. The specifications related to the build server, including each change to the build server, are documented. This typically includes Operating System (OS) version, Service Pack level and patches installed, making it easier to reproduce a build server.

In an embodiment, build server 110 compiles the source code of one or more SaaS services (computer applications) and bundles them as a service bundle JAR. It also copies the service bundles to a location accessible only to the repository server 120 over a secure channel. Once the service bundles have been generated and copied to a location accessible only to the repository server 120, the build server 110 posts a topic (a mechanism for publishing messages that may get delivered to multiple subscribers) on to the message bus server 140.

Repository server 120 is a computer server, which copies all the service bundles from the build server, over a secure connection, and stores them. Repository server may typically consist of a core and some non-essential components that add additional functionality. It may be accessed by a variety of client applications (such as web applications), and is capable of servicing requests over remote protocols. The repository server may be used to store service bundles for later downloading. It acts as the distribution channel of all the bundles to production servers. All the service bundles on the repository server are made accessible to production servers over any web protocol such as, but not limited to, http (Hypertext Transfer Protocol).

Repository server 120 also subscribes with the message bus server 140 for the topics posted by build server 110. It is also configured to post a topic (to message bus server 140) once it has downloaded one or more service bundles from the build server 110.

Production servers 130, 132, 134, 136 provide services to the end users or customers with computer systems 150, 152, 154, 156. A service container is run on the computer systems 150, 152, 154, 156. The production servers 130, 132, 134, 136 subscribe to the message bus server 140 for topics posted by the repository server 120.

Message bus server 140 is a message server which is used as a communication channel between all the servers 110, 120, 130, 132, 134, 136, 140.

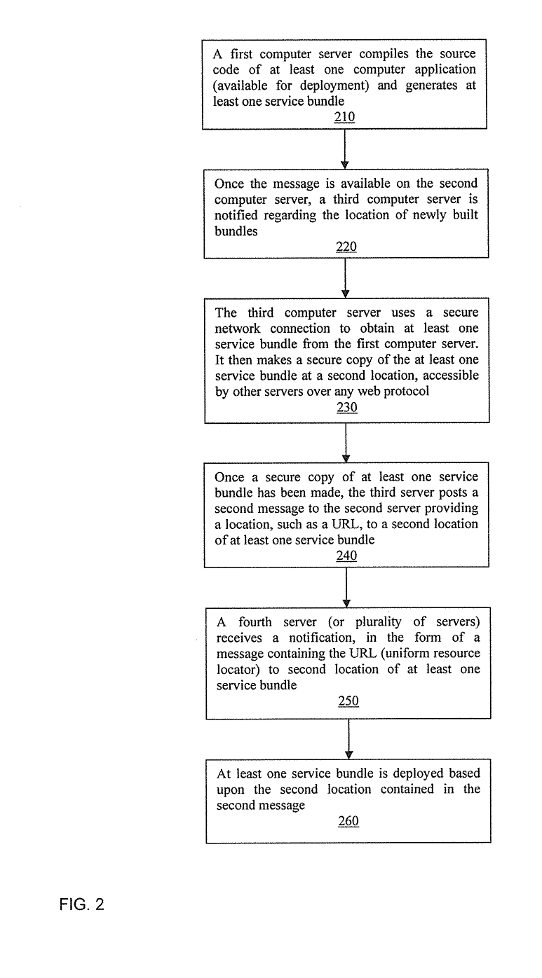

FIG. 2 shows a flow chart of a computer-implemented method of deploying SaaS service bundles according to an embodiment.

In step 210, a first computer server compiles the source code of at least one computer application (available for deployment) and generates at least one service bundle. It then posts a first message onto a second computer server. The message contains a first secure file system location of at least one service bundle. In an embodiment, the first computer server is a build server and the second computer server is a message bus server. In an embodiment, the functions of the first and the second server may be combined into a single server, i.e. the first server may also act as the second server. In an embodiment, at least one computer application may be a web application (an application that is accessed over a network such as the Internet or an intranet).

In step 220, once the message is available on the second computer server, a third computer server is notified regarding the location of newly built bundles. In an embodiment, the third computer server is a repository server. Also, the first location of at least one service bundle is accessible only to the third server.

In step 230, the third computer server uses a secure network connection to obtain at least one service bundle from the first computer server. It then makes a secure copy of the at least one service bundle at a second location, accessible by other servers over any web protocol such as, but not limited to, http (Hypertext Transfer Protocol).

In step 240, once a secure copy of at least one service bundle has been made, the third server posts a second message to the second server providing a location, such as a URL, to a second location of at least one service bundle.

In step 250, a fourth server (or plurality of servers) receives a notification, in the form of a message, containing the URL (uniform resource locator) to second location of at least one service bundle. In an embodiment, the fourth server (or plurality of servers) is/are a repository server(s).

In step 260, at least one service bundle is deployed based upon the second location contained in the second message. Prior to deployment, a configuration file based on URL to second location is generated. The configuration file is required to start services provided by one or more service bundles. If a service has not been deployed so far, the service bundle associated with the service is loaded, and the service is deployed. If a service is already in deployment, the service is updated with new service bundles.

The method steps described above may not necessarily be performed in the sequence as outlined above. The steps may be performed in any other sequence as well, with a step(s) being performed prior or later to other method steps.

Example illustrating deployment of SaaS service bundles using a messaging infrastructure according to an embodiment.

To demonstrate an exemplary deployment of SaaS service bundles using a messaging infrastructure, three XW8200 machines with 2 GB of RAM and 2.8 Ghz Pentium processors are used as a prototype. A first server acts as the build server, which hosts the sources of OSGi (Open Services Gateway initiative) bundles (service bundles). An Apache Ant 1.6.1 is used for the build process and an FTP server FileZilla V2.2.7 is used for sharing the distributable JARs with a second server—the repository server.

In the present example, the build server also acts as the JMS (Java Message Server) server (or the message bus server). JBoss 4.2.4 JMS Server is installed on the first server to facilitate communication between different servers. A queue, “DistributableJarQ”, is created on the JMS server to post messages informing creation of JARs. A topic by name “DeployableBundleTopic” is created on the JMS server to post messages when the service bundles are available for deployment.

Apache Tomcat 6.0.13 is installed on the second server (repository server) to expose the distributable JARs over HTTP to the production servers. JMS Agent is installed on the second server to listen to the “DistributableJarQ”. It then copies the JARs from the build server over an ftp connection onto the apache tomcat directory. Finally, it posts a message on to the “DeployableBundleTopic” on JMS server.

A third server acts as the production server. Eclipse Equinox 4.0 is installed on the production server. It is an OSGi container for hosting the services. JMS Agent is installed on the production sever, which is configured to listen to the “DeployableBundleTopic”. Once the JMS Agent receives a message on “DeployableBundleTopic”, it generates an OSGi configuration file based on the specified location. It also checks for any cached version of the bundle and cleans it. If the OSGi container is not operational, it starts the OSGi container. The OSGi container then reads from the configuration file and loads the bundle. If the OSGi container is already operational, the JMS agent runs an update for the bundle newly available on the repository server.

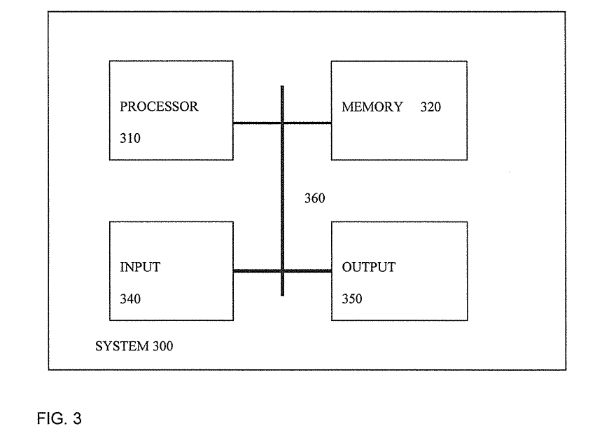

FIG. 3 shows a block diagram of a computer system that may be used in the system of FIG. 1 according to an embodiment.

The system 300 may be any kind of computing device, such as, but not limited to, a personal computer, a desktop computer, a server computer, a laptop computer, a notebook computer, a network computer, a personal digital assistant (PDA), a mobile device, a hand-held device, or any other suitable computing device. Further, the system 300 may be a standalone system or a network system connected to other computing devices through wired or wireless means.

The system 300 may include a processor 310, for executing software instructions, a memory 320, an input device 340 and an output device 350. These components may be coupled together through a system bus 360.

The processor 310 is arranged to compile a computer application to generate at least one service bundle, posting a first message containing a first location of the at least one service bundle, make a secure copy of the at least one service bundle at a second location, post a second message containing the second location of the at least one service bundle, and deploy the at least one service bundle based upon the second location contained in the second message.

The memory 320 may include computer system memory such as, but not limited to, SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc.

The input device 340 may include a mouse, a key pad, a touch pad or screen, a voice recognizer, and the like. The output device 350 may include a Virtual Display Unit (VDU), a printer, a scanner, and the like.

It would be appreciated that the system components depicted in FIG. 3 are for the purpose of illustration only and the actual components may vary depending on the computing system and architecture deployed for implementation of the present solution. The various components described above may be hosted on a single computing system or multiple computer systems, including servers, connected together through suitable means.

The embodiments described provide an effective mechanism to service providers for distributing and deploying SaaS services. The proposed solution automates the process of deployment, thus increasing productivity. It helps a service provider to reach customers faster with minimal manual intervention.

It will be appreciated that the embodiments within the scope of the present solution may be implemented in the form of a computer program product including computer-executable instructions, such as program code, which may be run on any suitable computing environment in conjunction with a suitable operating system, such as, Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present solution.

1. A computer-implemented method of deploying a SaaS (Software as a Service) service bundle, comprising:
compiling a computer application to generate at least one service bundle;
posting a first message containing a first location of the at least one service bundle;
making a secure copy of the at least one service bundle at a second location;
posting a second message containing the second location of the at least one service bundle; and
deploying the at least one service bundle based upon the second location contained in the second message.

2. A method according to claim 1, wherein the service bundle is deployed in an OSGi (Open Services Gateway initiative) environment.

3. A method according to claim 1, wherein the at least one service bundle is a JAR file.

4. A method according to claim 1, wherein the computer application is a web application.

5. A method according to claim 1, further comprising, prior to the deployment step, generating a configuration file based on the second location of the at least one service bundle, wherein the configuration file is used to deploy the at least one service bundle.

6. A method according to claim 1, wherein the first location of the at least one service bundle is accessible over a secure connection.

7. A method according to claim 1, wherein the second location of the at least one service bundle is a web URL (uniform resource locator).

8. A system for deploying a SaaS (Software as a Service) service bundle, comprising:
a plurality of servers connected over a network, wherein the plurality of servers comprises: a first server to compile a computer application in order to generate at least one service bundle and to post a first message containing a first location of the at least one service bundle; a second server to receive the first message containing a first location of the at least one service bundle; a third server to read the first message containing the first location of the at least one service bundle, to make a secure copy of the at least one service bundle at a second location and to post a second message containing the second location of the at is least one service bundle; and a fourth server to deploy the at least one service bundle based upon the second location contained in the second message.

9. A system according to claim 8, wherein the first server is a build server, the second server is a message bus server, the third server is a repository server, and the fourth server is a production server.

10. A system according to claim 8, wherein the second message containing the second location of the at least one service bundle is posted onto the second server.

11. A system according to claim 8, wherein the first location of the at least one service bundle is accessible only to the third server.

12. A system according to claim 8, wherein the secure copy of the at least one service bundle is generated over a secure connection between the first and the third server.

13. A system according to claim 8, wherein the at least one service bundle is a JAR file.

14. A system according to claim 8, wherein the first server also acts as the second server.

15. A computer program comprising computer readable means adapted to execute the method of claim 1 when said program is run on a computer system.
